(19) United States
(12) Patent Application Publication
(10) Pub. No.: US 2010/0028833 A1
(43) Pub. Date: Feb. 4, 2010

(54) DRILL FOR DENTAL USE AND WITH MODULATED INERTIA

(76) Inventor: Bernard Lambertin, Saint Lo (FR)

Correspondence Address: EGBERT LAW OFFICES, 412 MAIN STREET, 7TH FLOOR, HOUSTON, TX, 77002, US

(21) Appl. No.: 12/440,427

(22) PCT Filed: Sep. 27, 2007
(86) PCT No.: PCT/FR2007/052034

§ 371 Date: Mar. 6, 2009

(30) Foreign Application Priority Data
Oct. 23, 2006 (FR) 06/09264

(51) Int. Cl. A61C 3/02

(52) U.S. Cl. 433/165

(57) ABSTRACT

The invention relates to a drill for use in dentistry. The drill includes an active part, and a shank with a proximal part and a distal part. The proximal part has a variable inertia flywheel.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to the field of drills, in particular for use in dentistry.

It is of particular interest in dental applications such as endodontics, implantology, etc.

2. Description of Related Art Including Information Disclosed Under 37 CFR 1.97 and 37 CFR 1.98.

The drills used particularly in dentistry have a very wide variety of shapes and sizes, in addition to which they are used at different speeds.

To improve their working efficacy, attempts have been made to limit the jolts, due in particular to each tooth, when it comes into contact with the substance to be cut.

To achieve a smoothing of the rotation movement, the rotor of turbine handpieces (generally called turbines) has been modified, for example by adjunction of an inertia flywheel, or modifications have been made to the shapes of the bladed wheels which permit, among other things, greater power and, consequently, a movement less susceptible to micro-variations.

There is no doubt that these solutions do provide an improvement, but they are applied to the turbine and, consequently, apply regardless of the drill used or of the work carried out with said drill. Moreover, highspeed drills are also used on contra-angles with mechanical transmission, giving a speed of rotation of the drill close to that of the turbines during work, in which case greater power is thus available, since it is the power of the motor that is transmitted. At present, however, there is no means of combating the effects of the machining impacts.

### BRIEF SUMMARY OF THE INVENTION

An object of the present invention is to design a variable inertia drill in such a way that the inertia of the rotating assembly is adapted both to the drill and to the type of work for which it is intended.

Another object of the invention is to design a drill whose insertion is made easier and safer and which avoids the gloved fingers of the practitioner sliding on the proximal part of the sleeve of the drill.

These objects are achieved by the invention, which comprises a drill for dental use, of the type having an active part, a shank with a proximal part and a distal part, characterized in that the proximal part has a variable inertia flywheel.

### BRIEF DESCRIPTION OF THE SEVERAL VIEWS OF THE DRAWINGS

The invention will be better understood from the following description and by reference to the attached figures.

FIG. 1 shows a schematic view of a conventional dental drill.

FIG. 2 shows a schematic view of a dental drill according to the invention.

FIG. 3 shows a dental drill according to the invention engaged in a contra-angle or turbine head.

### DETAILED DESCRIPTION OF THE INVENTION

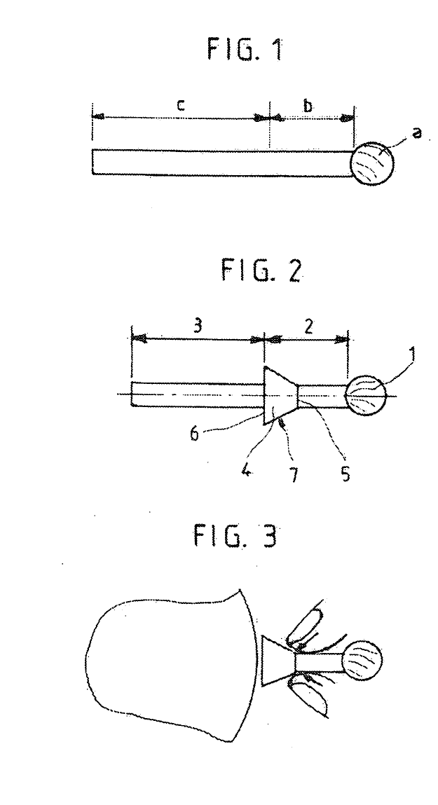

Dental drills (see FIG. 1) are generally composed of an active part (a) and of a sleeve or shank that can be divided into two parts, namely the proximal part (b), which is intended to remain outside the head of the turbine or contra-angle handpiece, and a distal part (c), which is intended to enter a handpiece, turbine or contra-angle. Said part (c) is generally defined according to current ISO standards depending on whether it is a drill for use on a low-speed or high-speed contra-angle.

FIG. 2 shows a drill according to the invention which comprises an active part (1), a distal part (3) for insertion into a handpiece, and a proximal part (2) that has a variable inertia flywheel (4) permitting adjustment of a flywheel as a function of the dimensions of the active part (1) and/or of the work to be carried out.

Preferably, as in the figures, the variable inertia flywheel (4) has a smaller diameter (5) towards the active part (1) and a greater diameter (6) towards the distal part (3) of the shank.

The base of greater diameter (6) is preferably situated at or very close to said distal part (3) in such a way as to serve as a visual marker for the practitioner, who is thus able to ascertain that the drill is engaged properly and to the correct depth in the clamping system of the handpiece.

The envelope (7) of the flywheel is preferably a conical surface of revolution, having the function of smoothing the movement of rotation by countering the jolts suffered by the drill during the dentistry work.

The envelope (7) could also be composed of discontinuous circular bearings of successive different diameters (case not shown).

By way of example, an inertia flywheel of approximately 3 mm and weighing 0.25 g gives satisfactory results.

When the drill is used with a spray system for example, the presence of the inertia flywheel means that the spray liquid and possible physiological liquids can be forced back outwards by a centrifugal effect, thereby preventing the penetration of these liquids into the head of the turbine, handpiece or contra-angle. This effect is heightened if the inertia flywheel is suitably given a shape such that it has a smaller diameter towards the drill than towards the handpiece.

Another function of the flywheel is to block the gloved fingers of the practitioner and to prevent their sliding on the drill (see FIG. 3).

A further function of the flywheel is to constitute a structural support of the drill shank by countering the whip phenomenon that can occur with drills used at high speed.

A further function of the flywheel is to constitute a means of protecting the handpiece against the spray saliva and other liquids during work.

The flywheel, if colored, can also serve for visual identification of the drills placed in a specific support generally used by dentists.

1. Drill for use in dentistry, said drill comprising:
an active part; and
a shank with a proximal part and a distal part, said proximal part having a variable inertia flywheel.

2. Drill according to claim 1, wherein the flywheel has a smaller diameter towards the active part and a greater diameter towards the distal part of the shank.

3. Drill according to claim 1, wherein the flywheel has an envelope formed by a conical surface of revolution.

4. Drill according to claim 3, wherein said envelope is comprised of circular bearings.
